(19) United States
(12) Patent Application Publication
(10) Pub. No.: US 2008/0165988 A1
(43) Pub. Date: Jul. 10, 2008

(54) Audio blending

(76) Inventors: Jeffrey J. Terlizzi, San Francisco, CA (US); Jeffrey A. Hammerstrom, Seattle, WA (US); Victor M. Tiscareno, Issaquah, WA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/650,002

(22) Filed: Jan. 5, 2007

(51) Int. Cl. H04B 1/00

(52) U.S. Cl. 381/119

(57) ABSTRACT

Systems, devices, and methods for blending audio signals are provided. In accordance with the present invention, a user can configure an audio device to receive sounds from the user's environment and selectively combine them with sounds generated by the device. This feature can be used with any device that generates audio signals (e.g. music player, telephone, two-way radio, etc.). The device can be configured by the user to personalize the combination of the sounds. For example, a user can select to filter the external sounds to remove unwanted noises or adjust the volume of the external sounds relative to the generated audio signals.

### BACKGROUND OF THE INVENTION

The present invention relates to audio signals. More particularly, the present invention relates to combining audio signals.

Most headphones limit the ability of a user to hear external sounds. Some headphones are designed with ear cups that fully enclose a user's ears, and other types of headphones, commonly called earbuds, are intended to be fully inserted into the ear canal. These devices block outside sound waves from reaching a user's ear drums and therefore interfere with their ability to hear the sounds of their environment.

In many situations, however, people may want to listen to their music privately without missing out on the sounds around them. For example, someone walking across a street may want to hear external sounds, such as car horns, while listening to their music. In another example, it might be nice for someone traveling in a new place to mix the sounds of a foreign environment with their own personal soundtrack.

Some headphones have attempted to solve this problem by including an unobstructed path for outside sounds to reach the ear. This solution is insufficient because it allows some of the sound generated by the speakers to leak into the outside environment. One negative effect of this leakage is that the audio quality heard by the user is lowered by the lost sound. Another problem with the leakage is that some of the user's privacy is lost because other people nearby might hear what they are listening to.

Therefore, it is desirable to provide a way for someone to listen to high-quality audio in private while still hearing the sounds of their environment.

### SUMMARY OF THE INVENTION

Systems, devices, and methods for blending audio signals are provided. In accordance with the present invention, a user can configure an audio device to receive sounds from the user's environment and combine them with sounds generated by the device. This feature can be used with any device that generates audio signals (e.g. music player, telephone, two-way radio, etc.). The device can be configured by the user to personalize the combination of the sounds. For example, a user can select to filter the external sounds to remove unwanted noises or adjust the volume of the external sounds relative to the generated audio signals.

In one embodiment, this feature can be implemented using circuitry located inside the audio device (e.g. music player, telephone, etc.). In this embodiment, a microphone can be included in the audio device or in a separate object which connects to the audio device. In another embodiment, the circuitry and microphone can be included in the headphones. This embodiment can be used to selectively blend external sounds with the audio output of any type of device.

### BRIEF DESCRIPTION OF THE DRAWINGS

The above and other features of the present invention, its nature and various advantages will be more apparent upon consideration of the following detailed description, taken in conjunction with the accompanying drawings.

FIG. 1 is an illustration of an embodiment of an audio blending system in accordance with the principles of the present invention;

FIG. 2 is a simplified schematic diagram of an embodiment of an audio blending system in accordance with the principles of the present invention;

FIGS. 3-8 are illustrations of sample screenshots of a user interface of a device which can be operated in accordance with the principles of the present invention;

FIG. 9 is an illustration of an embodiment of an audio blending device in accordance with the principles of the present invention;

FIG. 10 is a simplified schematic of an embodiment of an audio blending device in accordance with the principles of the present invention;

FIG. 11 is a flowchart of a method for blending audio signals in accordance with the present invention;

FIG. 12 is a flowchart of another method for blending audio signals in accordance with the present invention;

FIG. 13 is a flowchart of a method for blending and recording audio signals in accordance with the present invention; and

FIG. 14 is a flowchart of a method for suggesting and blending audio signals in accordance with the present invention.

### DETAILED DESCRIPTION OF THE INVENTION

In the discussion below, external sounds, background sounds and ambient sounds are all considered to be related to the sounds occurring around a user; and internal sounds, music and telephone audio are all considered to be related to the sounds generated internally by an audio device. In accordance with the present invention, the external sounds can be selectively blended with the internal sounds to create audio blends which are played for a user. The audio blends and combined audio output are both related to the sounds resulting from the combination of internal and external sounds.

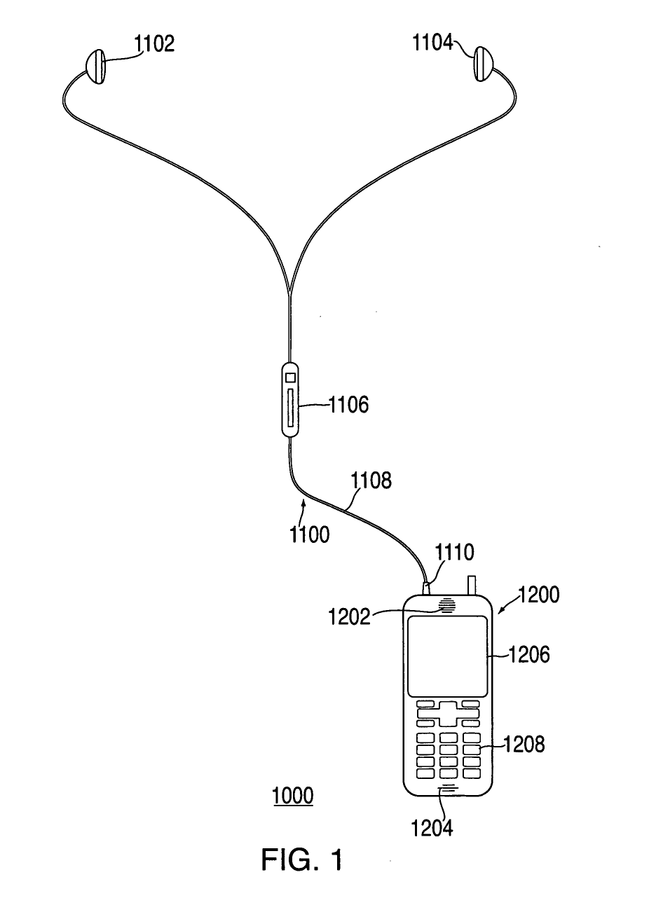

FIG. 1 includes an embodiment of an audio blending system 1000 which is operable in accordance with the principles of the present invention. System 1000 can include listening device 1100 and audio generation device 1200. In this embodiment, listening device 1100 is a set of headphones, but listening device 1100 can be any other device capable of converting electronic audio signals into sound waves in accordance with the present invention. In an alternative embodiment, listening device 1100 can be, for example, a car stereo system.

Headphones 1100 can include earpieces 1102 and 1104, microphone 1106, cable 1108 and connector 1110. Earpieces 1102 and 1104 can be, for example, fully enclosed earpieces, open-air earpieces or earbuds. Earpieces 1102 and 1104 can include a speaker driver to generate sound waves based on audio signals. Headphones 1100 can include microphone 1106. In this embodiment, microphone 1106 is located in-line with cable 1108. In other embodiments, microphone 1106 can be included in earpiece 1102, earpiece 1104 or both earpieces. It is contemplated that microphone 1106 can be one or more directional microphones in order to input sound from certain directions relative to the user. Headphones 1100 can include cable 1108 to connect earpieces 1102 and 1104 and microphone 1106 with connector 1110. Connector 1110 can be used to connect headphones 1100 with an audio generation device such as device 1200. It is contemplated that instead of using physical connector 1110, headphones 1100 can be wirelessly connected with an audio generation device 1200.

System 1000 includes audio generation device 1200. In this embodiment, audio generation device 1200 is a dual-function portable music player/cellular telephone, but audio device 1200 can be any device which generates audio signals. Audio device 1200 can include speaker 1202, microphone 1204, screen 1206 and keypad 1208. Speaker 1202 and microphone 1204 can be used as the telephone speaker and microphone of device 1200. Speaker 1202 and microphone 1204 can be automatically shut-off and replaced by earpieces 1102 and 1104 and microphone 1106 if headphones 1100 are connected with cable 1108 and connector 1110 to device 1200. Screen 1206 can be used to display information to a user, and a user can interface with keypad 1208 to input information and configure device 1200. A description of a user inputting information, for example selecting music or configuring a device, can relate to interacting with a user interface which includes a keypad or other input devices in combination with a screen or other display systems. Inputting information can also include storing the inputted data in memory within device 1200.

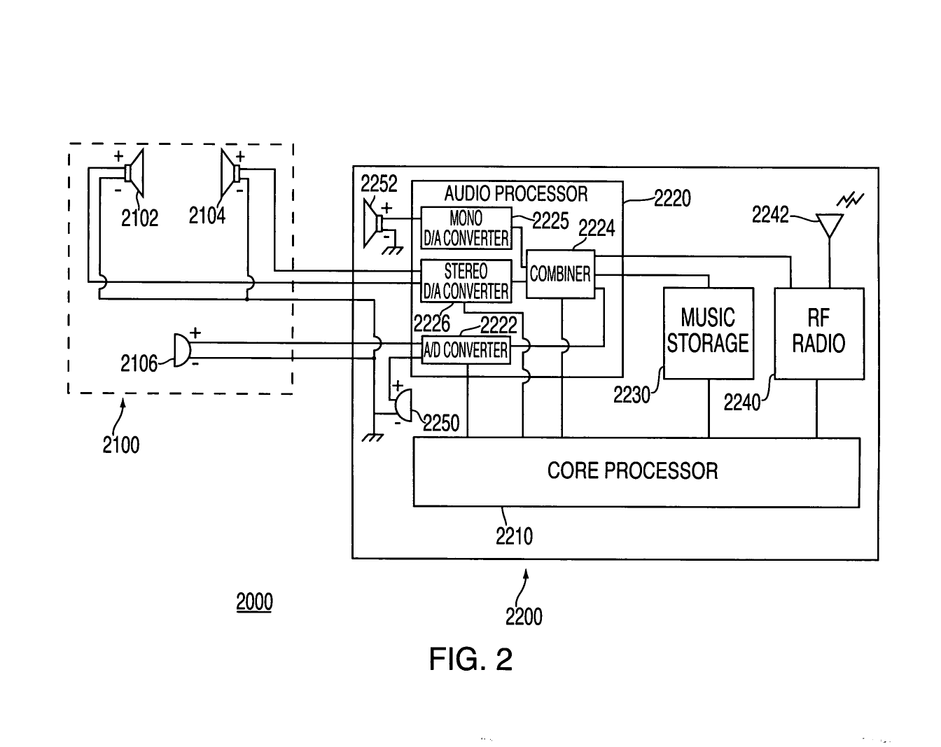

FIG. 2 is a simplified schematic diagram of an embodiment of an audio blending system 2000 which is operable in accordance with the principles of the present invention. System 2000 can include listening device 2100 and audio generation device 2200. Listening device 2100 can include speakers 2102 and 2104 which are operable to generate sounds based on audio signals. Listening device 2100 can include microphone 2106 which generates audio signals from sounds. In other embodiments, more than one microphone can be used. Microphone 2106, can also include multiple directional microphones so that sounds from one or more directions can be picked up as separate signals.

Audio generation device 2200 can include core processor 2210, audio processor 2220, music storage subsystem 2230, RF radio circuit 2240, microphone 2250 and speaker 2252. Core processor 2210 can be, for example, a 32-bit embedded microprocessor such as an ARM microprocessor. Core processor 2210 can coordinate the system-level functions of audio generation device 2200. Core processor 2210 can be coupled with audio processor 2220, music storage subsystem 2230 and RF radio circuit 2240.

Audio processor 2220 can also be called an audio digital signal processor. Audio processor 2220 can perform, for example, analog-to-digital conversions, digital-to-analog conversions, and various other audio processing tasks, such as filtering, combining, and amplifying/attenuating audio signals. Audio processor 2220 can be broken down into functional blocks including, for example, an analog-to-digital converter 2222, a digital combiner circuit 2224, and stereo digital-to-analog converters 2225 and 2226. Audio processor 2220 can include additional functional blocks (not shown) which are involved in other functions of device 2200. Audio processor 2220 can be coupled with the inputs and outputs of audio generation device 2200.

Music storage subsystem 2230 can access and store audio files when instructed to by core processor 2210. Music storage subsystem 2230 can include, for example, flash memory chips or hard disk drives for storing audio files. The inputs and outputs of music storage subsystem 2230 can be coupled to audio processor 2220. Music storage subsystem 2230 can generate audio signals based on files and output them to audio processor 2220. Music storage subsystem 2330 can perform other functions as well. For example, music storage subsystem 2330 can receive audio signals from audio processor 2220 and store them as files.

RF radio circuit 2240 can include RF antenna 2242. RF antenna 2242 can receive and transmit cellular transmissions and RF radio circuit 2240 can, for example, convert audio signals to corresponding RF signals and vice-versa. The inputs and outputs of RF radio circuit 2240 can be coupled to audio processor 2220.

Microphone 2250 can be used for telephone and audio blending functions. Microphone 2250 can be coupled to audio processor 2230 so that the signals from microphone 2250 can be inputs for audio processor 2230. Microphone 2250 can be used in combination with, or in place of, microphone 2106. Alternatively, microphone(s) for the audio blending process can be included within one or both of speakers 2102 and 2104 (and, similarly, speakers 1102 and 1104 of FIG. 1).

An analog-to-digital converter 2222 in audio processor 2220 can generate digital audio signals based on the output of microphone 2106, microphone 2250 or both. Analog-to-digital converter 2222 can include filters to process the audio signals. The filters in analog-to-digital converter 2222 can be configured by core processor 2210. For example, a user can input a set of desired filter parameters which core processor 2210 can relay to analog-to-digital converter 2222. These parameters can include, for example, volume (or amplification gain) and equalizer settings (or frequency response). It is also contemplated that core processor 2220 can automatically adjust the filter parameters sent to analog-to-digital converter without a change in user input. The output of analog-to-digital converter 2222 can be coupled with an input of combiner 2224. It is further contemplated that a similar hardware configuration can also be used to cancel out, using the principles of active noise reduction, the external sounds heard by a user.

To increase the audio quality of sounds picked up by microphones 2106 and 2250, a microphone calibration procedure can be used in accordance with an embodiment of the present invention. For example, a speaker can be placed in proximity to a microphone and output a test tone (e.g. a signals that includes a frequency sweep). The audio signals picked up by the microphone can then be analyzed, and an audio filter which compensates for the performance of the microphone can be generated.

Music storage subsystem 2230 and RF radio circuit 2240 can be directed by core processor 2210 to output digital audio signals to combiner 2224. For example, a user can select music to listen to and core processor 2230 can instruct music storage subsystem 2230 to access one or more corresponding files and transmit the data to combiner 2224. Combiner 2224 can blend the different audio signals together. Combiner 2224 can also modify audio signals in addition to combining them. For example, core processor 2210 can instruct combiner 2224 regarding which signals to combine and what relative amplifications to use. What this means is that core processor 2210 can, for example, instruct combiner 2224 to lower the volume of the signal from analog-to-digital converter 2222 and increase the volume of the signal from music storage subsystem 2230.

This is an example of one automatic level control (ALC) algorithm that can be used to change the relative volume of the different audio signals. There are other ALC algorithms which can be used in accordance with the present invention. For example, another ALC algorithm might only adjust the volume of the signal from the external sounds while the volume of the internal signal remains unchanged. As an additional example, the ALC circuitry can recognize certain conditions and implement automatic gain control. For example, such circuitry can automatically lower the gain (or completely turn off blending) if a feedback condition (e.g. when an earbud is placed to close to a microphone) is detected.

After the incoming audio signals have been modified and/or blended, combiner 2224 can output the signals to mono digital-to-analog converter (DAC) 2225 or stereo DAC 2226. Which DAC combiner 2224 outputs to can be dependant upon the status of audio generation device 2200. For example, device 2200 might automatically use DAC 2225 and speaker 2252 if listening device 2100 is not connected.

Digital-to-analog converters (DACs) 2225 and 2226 can convert digital audio signals into analog audio signals. Mono DAC 2225 can output a signal representing a single audio channel to speaker 2252 in audio generation device 2200. Stereo DAC 2226 can output audio signals representing a left audio channel to speaker 2102 and audio signals representing a right audio channel to speaker 2104. DACs 2225 and 2226 can amplify their output to a level suitable for the speakers they are coupled to. Additionally, DACs 2225 and 2226 can amplify their output to a listening volume specified by the user.

In an alternative embodiment, device 2200 can blend signals in their analog forms without deviating from the spirit of the present invention. In this embodiment, the incoming analog signals can be combined with the internal signals after the internal signals have been converted from digital-to-analog. In this case, incoming analog signals can be amplified and filtered using analog circuitry.

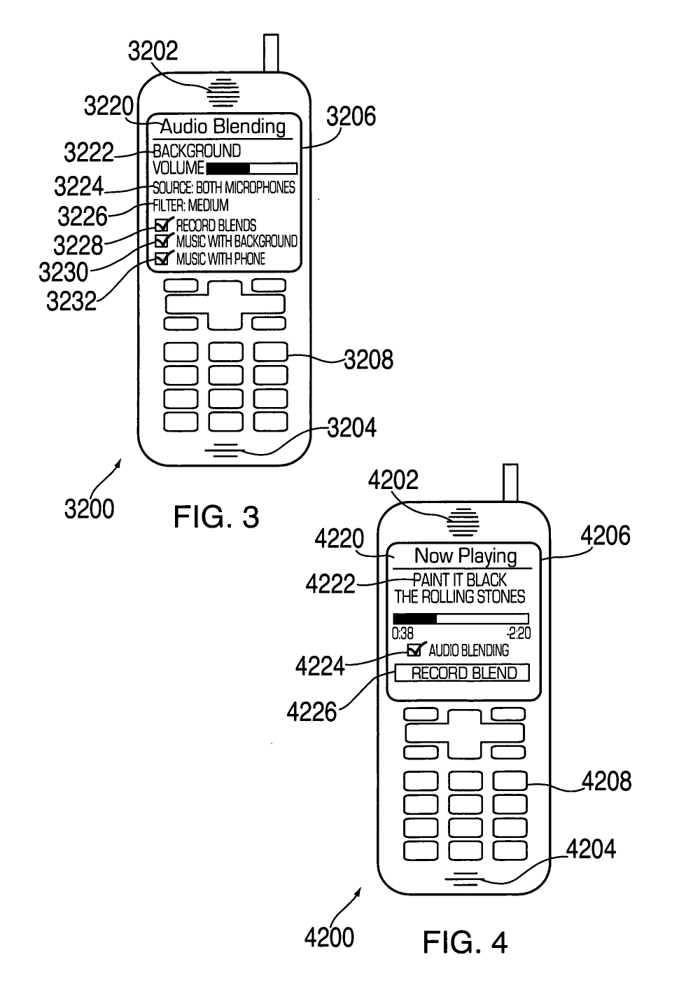

FIG. 3 includes a sample screenshot of the user interface of audio generation device 3200 when audio generation device 3200 is being configured for audio blending. Audio generation device 3200 can include speaker 3202, microphone 3204, screen 3206, and keypad 3208. Screen 3206 can be used to display information to a user, and keypad 3208 can be used to accept user input. It is contemplated that a voice recognition system can be used to accept user input in accordance with the present invention.

Screen 3206 can include title 3220 to indicate the information being displayed to the user. Screen 3206 can also include graphics or text to edit and display the settings which control the audio blending of device 3200. Screen 3206 can display volume setting 3222 which can be used to set the volume level of background sound in the blend. This volume level can be the absolute volume of external sounds or the volume of the external sounds relative to internal sounds. What this means is that device 3200 can analyze the average volume of internal sounds and adjust the volume of external sounds accordingly or vice versa. Volume setting 3222 can be displayed through, for example, a rectangular graphic that shows what percentage of maximum volume is currently selected. Another example of a suitable volume setting can be a rectangular graphic with an indicator (or fulcrum) representing the ratio (or balance) of external sound volume with respect to internal sound volume. For example, if the indicator were in the center of the graphic, it can relate to an even balance between the two volumes. If the indicator were offset to one side, the relative volume can change accordingly.

Screen 3206 can also include a source option 3224 that determines which microphones a device uses to input background sounds. Source option 3224 can include choices that relate to individual or combinations of microphones (e.g. headset microphone, hand-held microphone, both microphones, etc.). Source option 3224 can also include selections relating to directional microphones so that a user can configure device 3200 to blend sounds from certain directions or combinations of directions (e.g. front, sides, rear, front and sides, etc.).

Screen 3206 can include filter setting 3224 to determine if and how incoming ambient sound should be processed. This filter setting can include a variety of modes with predefined equalizer settings. Filter setting 3224 can also allow a user to define their own customized equalizer settings in accordance with the present invention. Filter setting 3224 could also include the option to filter the incoming ambient sounds according to volume. For example, filter setting 3224 can be configured so that sounds below a predetermined volume threshold (e.g. fans, distant automobiles, etc.) would not be blended into the audio. Filter setting 3224 can also include the option to filter low-frequency elements out of the ambient sounds. For example, a high-pass filter could be applied to the background sounds. In another type of filtering, static sounds can be removed from the ambient sounds. What this means is that sounds which do not vary significantly in pitch could be removed from the background sounds. Moreover, an audio blending device can be configured to monitor ambient noises for certain sounds. For example, a device can be programmed to recognize the sound made by car horns and initiate a predetermined action. Examples of appropriate predetermined actions can include muting all other sounds or warning a user. Such actions can increase a user's safety in potentially dangerous situations, such as crossing the street or riding a bicycle/motorcycle.

Screen 3206 can also include a recording setting 3228 to select if and how the audio blends should be recorded by device 3200. In accordance with the present invention, device 3200 can be configured to record the blends and then automatically store them. Alternatively, device 3200 can be configured to record blends as they are generated and played, but only store each blend if a user selects to do so. In this case, a blend can be erased from device 3200 if a user does not select to store the blend before a predetermined time. This predetermined time can be the time at which the blend is finished playing.

Screen 3206 can include settings for selecting which sounds should be blended together. Two examples of this type of setting are option 3230, which can be used to set device 3200 to blend background sounds with music, and option 3232, which can be used to set device 3200 to blend phone audio with music. In the case of blending phone audio with music, the outgoing signal in a telephone conversation, which includes the user's voice picked up by a microphone, can be blended with a music signal so that the blended signal is transmitted as the combined outgoing telephone signal. In this example, the user's voice is related to background sounds because they both are picked up by a microphone.

It is contemplated that the blending configuration of device 3200 can be saved as a profile. More than one profile can be stored on memory in device 3200 so that the device can switch between different profiles. Device 3200 can switch profiles in response to user input or as an automatic response to predetermined sets of conditions (e.g. low battery power, etc.).

FIG. 4 includes a sample screenshot of the user interface of audio generation device 4200 when audio generation device 4200 is playing a blend of music and ambient sounds. Audio generation device 4200 can include speaker 4202, microphone 4204, screen 4206, and keypad 4208. Screen 4206 can be used to display information to a user, and keypad 4208 can be used to accept user input.

Screen 4206 can include title 4220 to display what device 4200 is doing. Screen 4206 can also include music information 4222 about what music is being played. Music information 4222 can include song name, album name, artist name, genre, and any other information that might be part of a music file on device 4200. Music information 4222 can include graphical representations of this information as well. Music information 4222 can include, for example, an image of an album cover or a graphical depiction of the elapsed and total time. Screen 4206 can also include a graphic which could provide realtime visualizations of the incoming ambient sounds, the generated internal sounds, or the resulting blend (not shown).

Screen 4206 can include a disable option 4224 to temporarily stop audio blending. If selected by a user, disable option 4224 can mute the background sounds so that only the music is played. It is contemplated that the volume of background sound in the blend can be adjusted while music is playing (not shown). Screen 4206 can also include a record option 4226 which can be selected by a user to store the current blend, which can be a blend of one song, an entire album, or any other amount of music, in memory on device 4200 for later playback or transfer to another device. It is contemplated that in order to store the blend, only the background sounds need to be stored because the music will already be stored on device 4200. In this case, when a blend is replayed, device 4200 could access both files simultaneously and re-blend the signals. If record option 4226 is selected device 4200 can proceed by prompting a user for a name to use for the blend, or the device can automatically assign a name to the blend. This automatically assigned name can include information such as time/date and the music in the blend. It is contemplated that recording blends in accordance with the present invention allows a user to record homemade sing-a-longs by singing, into a microphone, along with the music while a blend is being recorded.

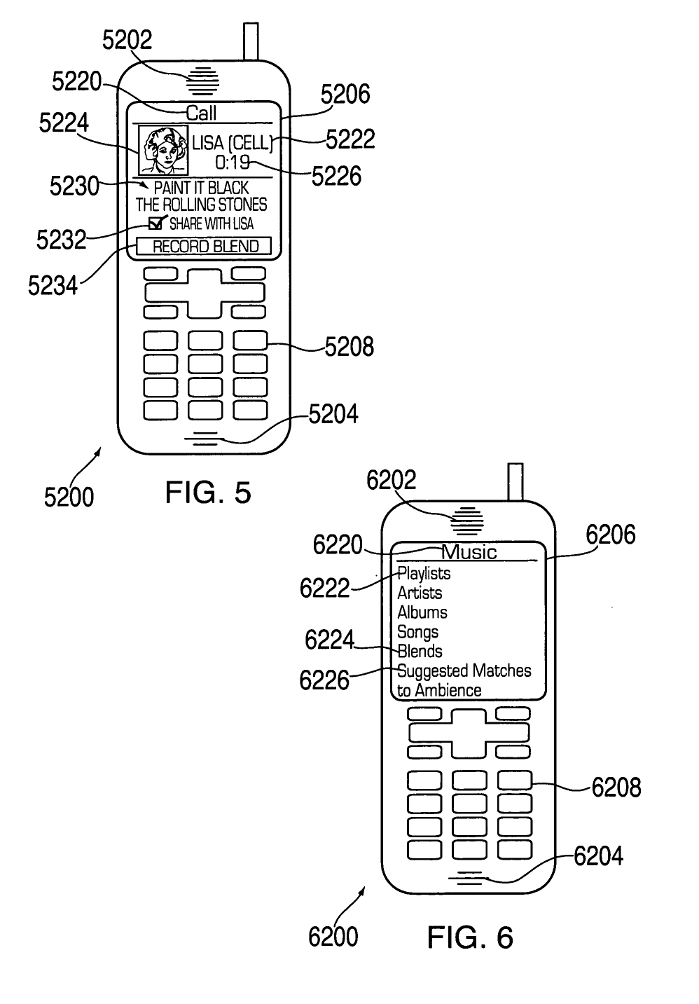

FIG. 5 includes a sample screenshot of the user interface of audio generation device 5200 when audio generation device 5200 is blending music and a telephone conversation. Audio generation device 5200 can include speaker 5202, microphone 5204, screen 5206, and keypad 5208. Screen 5206 can be used to display information to a user, and keypad 5208 can be used to accept user input.

Screen 5206 can include title 5220 to indicate what state device 5200 is in. Screen 5206 can include general information about a telephone call. For example, screen 5206 can include name 5222 or number of who a user is connected with, picture 5224 of who a user is connected with, and the total time 5226 of a telephone call. Screen 5206 can also include music information 5230 about any music it is playing. Music information 5230 is comparable to music information 4222 in FIG. 4.

Screen 5206 can include share option 5232. If a user selects share option 5204, any music that is playing can be shared with someone else in the telephone conversation. This can be done by combining any music that is playing with audio from a microphone. This blended audio can then be sent to an RF transmitter which can send it as part of a cellular telephone call. If share option 5204 is not selected, device 5200 can combine incoming telephone audio with music so that only the user can hear the music. In a third mode, device 5200 can pause any music that is playing when a telephone call is initiated.

Screen 5206 can also include a graphical representation of a record button 5234 which can be used to record audio blends. If a user selects record button 5234, device 5200 can store the current audio blend. In the situation where music and a telephone conversation are blended, the recorded blend can include, for example, the music and both sides of the conversation. It is contemplated that the hardware necessary to record these blends could also be used for recording telephone conversations when no music is being played.

FIG. 6 includes a sample screenshot of the user interface of audio generation device 6200 when audio generation device 6200 is accessing stored music and blends. Audio generation device 6200 can include speaker 6202, microphone 6204, screen 6206, and keypad 6208. Screen 6206 can be used to display information to a user, and keypad 6208 can be used to accept user input.

Screen 6206 can include title 6220 which can inform a user about what is being displayed on screen 6206. Screen 6206 can also include list 6222 of different ways to group or display music on device 6200. As part of list 6222, screen 6206 can include selection 6224 for blends. A user could choose selection 6224 to access and play previously recorded blends. As another part of list 6222, screen 6206 can include a selection 6226 for device 6200 to suggest music that matches the current ambient noise. If selection 6226 is chosen, device 6200 can, for example, analyze a sample of ambient sound in order to determine various parameters (e.g. average volume, beats-per-minute, etc.). These parameters can be compared against parameters relating to music stored in device 6200. From these comparisons, a list of music that might complement the ambient sounds can be generated. Once this list is generated, music can be automatically selected or chosen by a user to be played. While this music is being played in can be blended with the ambient noise in accordance with the principles of the present invention.

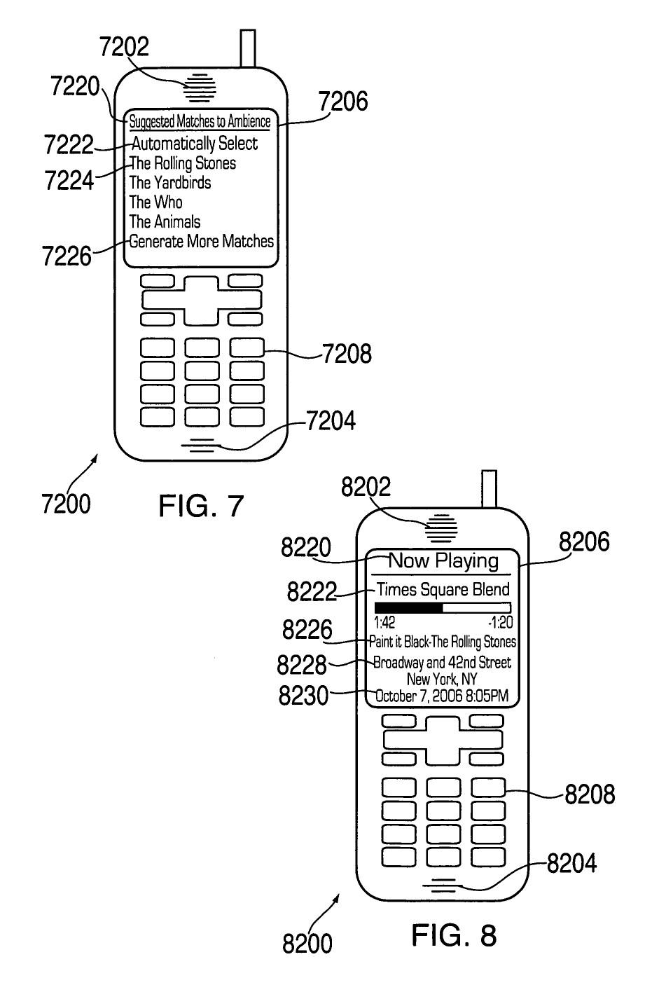

FIG. 7 includes a sample screenshot of the user interface of audio generation device 7200 when audio generation device 7200 is displaying a list of music suggest to match the ambient sounds. Audio generation device 7200 can include speaker 7202, microphone 7204, screen 7206, and keypad 7208. Screen 7206 can be used to display information to a user, and keypad 7208 can be used to accept user input.

Screen 7206 can include title 7220 which can indicate what is being displayed on screen 7206. Screen 7206 can also include a list of different options relating to music that has been suggested to match the current ambient sounds. Screen 7206 can include an automatically select option 7222 which a user can select to instruct device 7200 to play music from the previously generated list. If automatically select option 7222 is chosen, device 7200 may continue to automatically select new music as the sounds of the environment change. Screen 7206 can also include a list 7224 of music that might complement the ambient sounds. Screen 7206 can include an option 7226 for a user to instruct device 7200 to generate more suggestions. More suggestions can, for example, be generated by broadening the search criteria that was originally applied to the music stored in device 7200.

FIG. 8 includes a sample screenshot of the user interface of audio generation device 5200 when audio generation device 5200 is playing a previously recorded blend of music and ambient sounds. Audio generation device 8200 can include speaker 8202, microphone 8204, screen 8206, and keypad 8208. Screen 8206 can be used to display information to a user, and keypad 8208 can be used to accept user input.

Screen 8206 can include title 8220 to display what device 8200 is doing. Screen 8206 can also include blend name 8222 which can be automatically generated or selected by a user when a blend is created. Screen 8206 can also include music information 8226 about music that is part of the blend being played. Screen 8206 can also include location information 8228 about the location where the blend being played was recorded. Location information 8228 can be defined by a user when a blend is created. If device 8200 is capable of determining its own location, for example through a Global Positioning System, then location information 8228 could be automatically generated when a blend is created. Screen 8206 can include date/time information 8230 which can be automatically generated from a clock within device 8200 when a blend is created. It is contemplated that, while some of the information about a blend can be automatically generated when it is created, any of the information can be edited at a later point.

In accordance with the present invention, pictures or videos might be displayed while a blend is playing. If device 8200 includes a camera (not shown), a user can take pictures or videos while device 8200 is recording a blend and these pictures or videos can be displayed to the user when the blend is replayed. The pictures can be displayed in a slideshow in order to recreate an additional aspect of the atmosphere in which the blend was recorded.

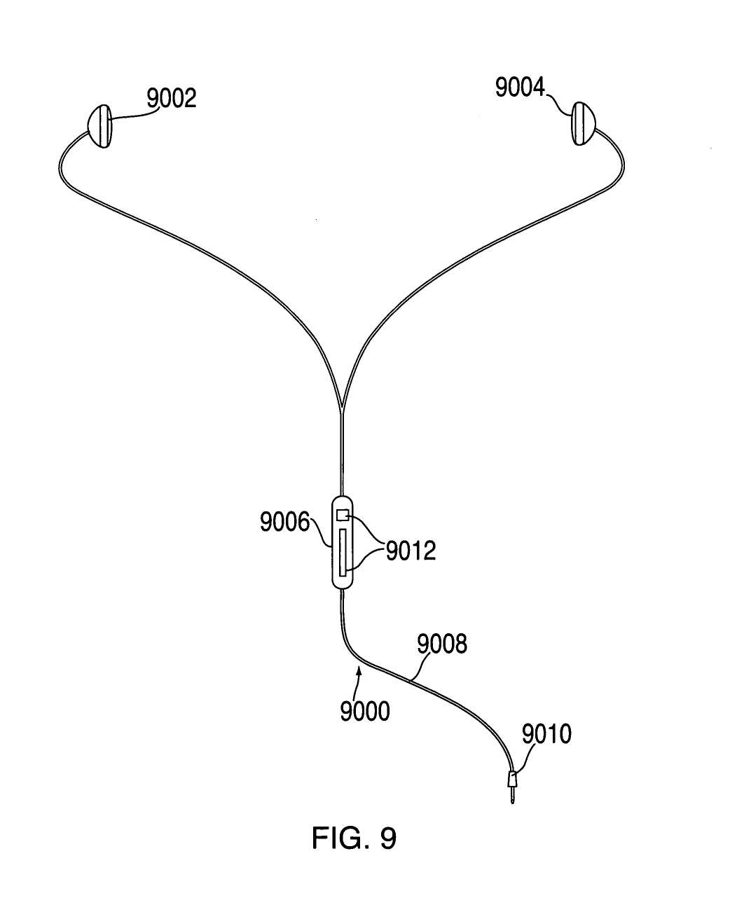

FIG. 9 includes an embodiment of an audio blending device 9000 which is operable in accordance with the principles of the present invention. Device 9000 can include earpieces 9002 and 9004, microphone 9006, cable 9008, connector 9010, and switch 9012. Earpieces 9002 and 9004 can be, for example, fully enclosed earpieces, open-air earpieces, or earbuds. Earpieces 9002 and 9004 can include a speaker driver to generate sounds based on electronic audio signals. In this embodiment, microphone 9006 is located in-line with cable 9008. In other embodiments, one or more microphone can be included in earpiece 9002, earpiece 9004 or both earpieces. It is contemplated that one or more directional microphones can be used in order to input sound from certain directions relative to the user. Cable 9008 can be used to connect the elements of device 9000. Connector 9010 can be used to connect device 9000 with a source of electronic audio signals (e.g. music player, etc.). In this embodiment, connector 9010 is a physical connector, but it can be replaced with, for example, a wireless connection without deviating from the spirit of the present invention.

Device 9000 can also include blending circuitry (not shown) which can be used to blend audio signals in accordance with the present invention. Blending circuitry can be located anywhere in device 9000, including earpieces 9002 and 9004, microphone 9006, and connector 9010. Device 9000 can also include a battery to power blending circuitry (not shown).

User interface 9012 can be included in device 9000 so that a user can control the blending process. Interface 9012 can include, for example, a power switch and a volume fader. Power switch can be operable to turn blending circuitry on or off, and volume fader can be a potentiometer operable to set the volume of external sounds that should be blended with the incoming audio signal. It is contemplated that a single switch can function as a volume fader as well as an on/off switch. Such a switch can include a range of fader positions as well as a position that turns the device completely off. Interface 9012 can include additional switches to control device 9000. For example, interface 9012 can include switches to set filter parameters that the blending circuitry can use to filter external sounds.

In accordance with the present invention, device 9000 can receive audio input signals at connector 9010 and combine those signals with ambient sound from microphone 9006. This combination can be generated by circuitry within device 9000 and then played for a user through earpieces 9002 and 9004. A user can configure device 9000 in order to set various parameters (e.g. volume, filtering, etc.) that control the blending.

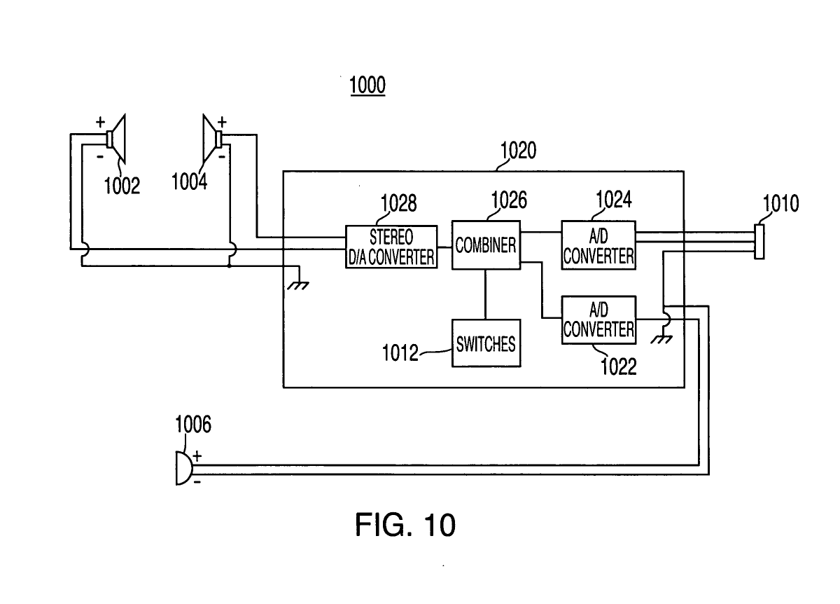

FIG. 10 includes an embodiment of audio blending device 1000 which is operable to blend sound in accordance with the present invention. Device 1000 can include speakers 1002 and 1004, microphone 1006, connector 1010, and blending circuitry 1020. Speakers 1002 and 1004 can be located in ear pieces so that they are able to play sound for a user. Microphone 1006 can convert ambient sounds into audio signals. Connector 1010 can interface with other devices in order to input other audio signals into device 1000. Blending circuitry 1020 can combine signals from microphone 1006 and connector 1010. Blending circuitry 1020 can output the blended combination of signals to speakers 1002 and 1004 which can play the combination for the user.

Blending circuitry 1020 can include one or more switches 1012, analog-to-digital converters 1022 and 1024, combiner 1026, and stereo digital-to-analog converter 1028. Analog-to-digital converters 1022 and 1024 can be operable to receive analog audio signals from microphone 1006 and connector 1010 and convert those signals into digital audio signals. Analog-to-digital converters 1022 and 1024 can filter and amplify the incoming signals as part of the blending process. Combiner 1026 can create a blend of the two signals according to the inputs of one or more switches 1012. A user can interface with switches 1012 in order to control, for example, the relative volumes of each signal in a blend. It is contemplated that switches 1012 can also control other elements in blending circuitry 1020. Stereo digital-to-analog converter 1028 can convert digital audio signals to stereo analog signals to be played through speakers 1002 and 1004. Digital-to-analog converter 1028 can also amplify audio signals to an appropriate level for speakers 1002 and 1004.

Although the embodiment in FIG. 10 uses digital circuitry to combine the audio signals, it is contemplated that this can be done in other ways. For example, analog circuitry can be used to blend the signals in accordance with the present invention. If analog circuitry is used, the analog-to-digital and the digital-to-analog converters might not be needed.

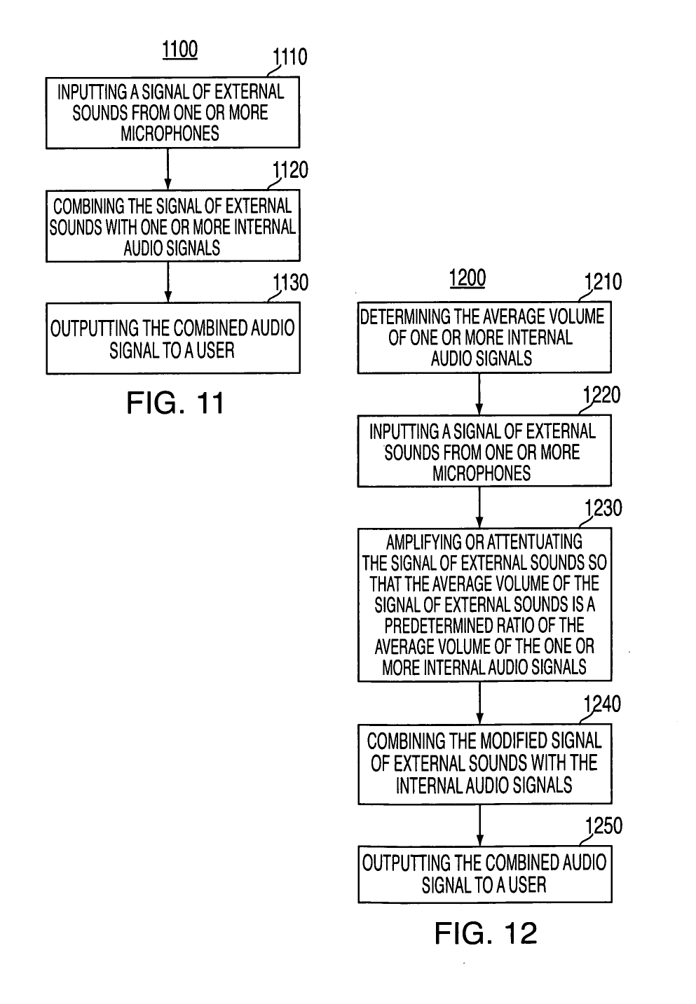

FIG. 11 is a flowchart of method 1100 for audio blending in accordance with the present invention. At step 1110, one or more microphones can receive a signal of external sounds. At step 1120, circuitry can combine the signal of external sounds with one or more internal audio signals to create a combined audio signal. At step 1130, the combined audio signal can be outputted to a user.

FIG. 12 is a flowchart of method 1200 for audio blending in accordance with the present invention. At step 1210, circuitry can determine the average volume of one or more internal audio signals. At step 1220, one or more microphones can receive a signal of external sounds. In accordance with the present invention, the order of steps 1210 and 1220 are interchangeable. At step 1230, circuitry can amplify or attenuate the signal of external sounds so that the average volume of the signal of external sounds is a predetermined ratio of the average volume of the one or more internal audio signals. Step 1230 illustrates one way to change the volume of external sounds relative to internal sounds, but this can be done in other ways without deviating from the spirit of the present invention. At step 1240, circuitry can combine the modified signal of external sounds with the internal audio signal. At step 1250, a device can output the combined audio signal to a user.

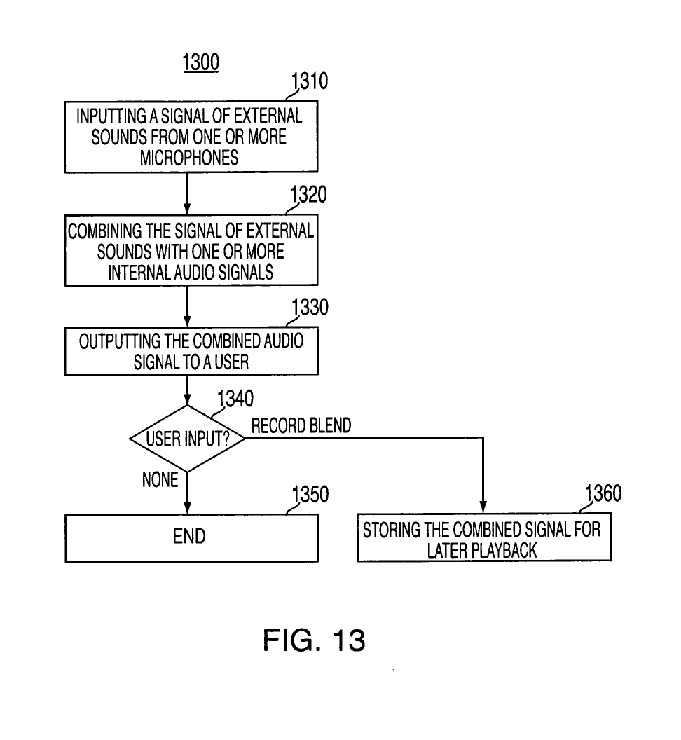

FIG. 13 is a flowchart of method 1300 for audio blending in accordance with the present invention. At step 1310, one or more microphones can receive a signal of external sounds. At step 1320, circuitry can combine the signal of external sounds with one or more internal audio signals to create a combined audio signal. At step 1330, the combined audio signal can be outputted to a user. At step 1340, a user can input a command if they would like to record the combined audio signal. If no command is given, the process can end at step 1350. If a command to record the combined signal is given, the combined signal can be stored on memory at step 1360.

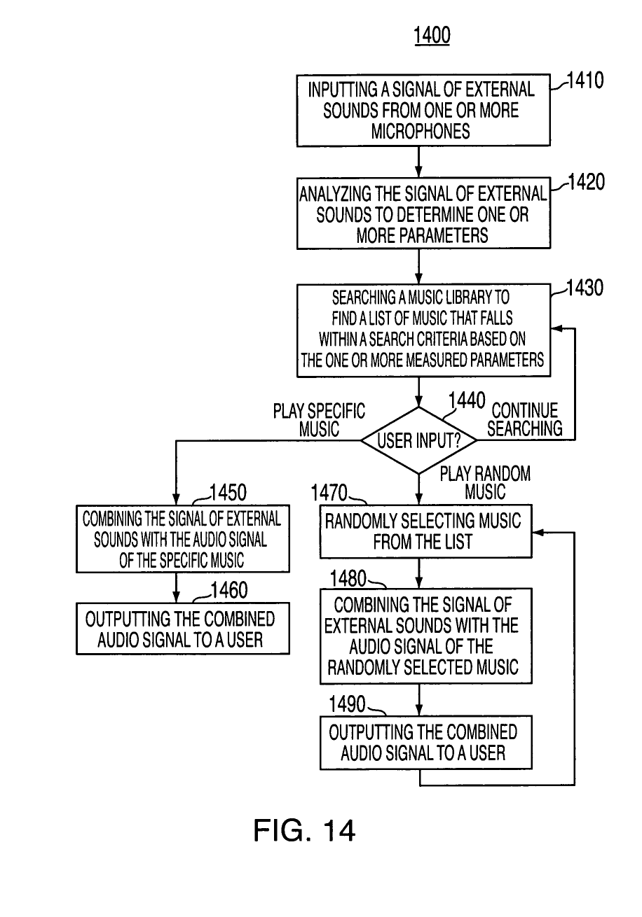

FIG. 14 is a flowchart of process 1400 for suggesting music that complements external sounds. At step 1410, one or more microphones can input a signal of external sounds. At step 1420 circuitry can analyze the signal of external sounds to determine one or more parameters. At step 1430, circuitry can search a music library to find a list of music that falls within a search criteria based on one or more measured parameters. The music library can, for example, include all of the music stored on a portable music player. At step 1440, the process diverges depending on whether a user selects to play specific music from the list, play music randomly selected from the list, or continue searching.

If a user is not satisfied with the current list of music, the user can choose to generate a new list. In this instance, the search criteria might be expanded so that new music will be included in the new list. If a user selects to play specific music from the list, circuitry can combine the signal of external sounds with the audio signal of the specific music at step 1450. At step 1460, the combined audio signal can be outputted to a user.

If a user selects to play music randomly selected from the list, this random selection can be made at step 1470. At step 1480, circuitry can combine the signal of external sounds with the audio signal of the randomly selected music. At step 1490, the combined audio signal can be outputted to a user. After the randomly selected music is through playing, the process can automatically proceed by randomly selecting other music from the list. In an alternative embodiment, the external sounds can be reanalyzed, a new list of music can be generated, and music can be randomly selected so that the new music corresponds to the current environmental sounds. This can be useful in a situation where a user is moving through different environments, each with their own sounds.

Thus it is seen that descriptions of audio blending systems, devices, and methods are provided. A person of ordinary skill in the art will appreciate that the present invention may be practiced by other than the described embodiments, which are presented for purposes of illustration rather than of limitation.

What is claimed is:

1. An audio blending method comprising:
receiving audio signals of external sounds from one or more microphones;
selectively combining the audio signals of external sounds with one or more internal audio signals based on at least the received external sounds; and
outputting the combined audio signal to a user.

2. The method of claim 1 further comprising:
filtering the signals of external sounds according to a predefined set of user parameters before combining the signals of external sounds with one or more internal audio signals.

3. The method of claim 1 wherein the internal audio signals are generated from files on a storage device.

4. The method of claim 1 wherein the internal audio signals are generated from a cellular communications device.

5. The method of claim 1 wherein combining comprises:
applying an automatic level control algorithm to the signals.

6. The method of claim 1 wherein the combined audio signal is output through a set of headphones.

7. The method of claim 6 wherein the set of headphones is operable to generate output so that only a user can hear it.

8. An audio blending method comprising:
determining the average volume of one or more internal audio signals;
receiving audio signals of external sounds from one or more microphones;
modifying the received audio signals of external sounds;
selectively combining the modified audio signals of external sounds with the internal audio signals based on at least the received external sounds; and
outputting the combined audio signals to a user.

9. The method of claim 8 wherein determining the average volume of one or more internal audio signals comprises:
reading information that is stored in an audio file's header.

10. The method of claim 8 wherein modifying the signal of external sounds comprises:
amplifying or attenuating the signals so that the average volume of the signal of external sounds is a predetermined ratio of the average volume of the one or more internal audio signals.

11. The method of claim 10 wherein the predetermined ratio can be set by the user.

12. An audio blending method comprising:
receiving audio signals of external sounds from one or more microphones;
selectively combining the received audio signals of external sounds with one or more internal audio signals based on at least the received external sounds;
outputting the combined audio signals to a user; and
storing the combined signals for later playback.

13. An audio blending method comprising:
receiving signals of external sounds from one or more microphones;
analyzing the received audio signals of external sounds to determine one or more parameters; and
searching a music library to find a list of music that falls within a search criteria based on the one or more measured parameters.

14. The method of claim 13 further comprising:
selectively combining the received audio signals of external sounds with the audio signal of music selected by a user from the list based on at least the received external sounds; and
outputting the combined audio signals to the user.

15. The method of claim 13 further comprising:
randomly selecting music from the list;
selectively combining the received audio signals of external sounds with the audio signal of the randomly selected music based on at least the received external sounds; and
outputting the combined audio signal to a user.

16. The method of claim 13 further comprising:
re-searching the library to find a list of music that falls within a search criteria based on the one or more measured parameters.

17. A portable audio blending system comprising:
one or more batteries;
one or more speakers;
one or more microphones; and
an audio generation device comprising:
a source of internal audio signals;
audio processing circuitry coupled with the one or more microphones, the source of internal audio signals, and the one or more speakers, wherein the audio processing circuitry is operable to selectively combine audio signals from the one or more microphones with internal audio signals based on at least the received external sounds and output the combination to the one or more speakers.

18. The system of claim 17 wherein the one or more speakers are part of a headphone apparatus.

19. The system of claim 17 further comprising:
a user interface which controls the audio processing circuitry.

20. The system of claim 17 further comprising:
a storage device operable to store the combination of signals.

21. The system of claim 17 wherein the audio processing circuitry is operable to apply an automatic level control algorithm to the signals being combined.

22. A portable audio blending device comprising:
one or more batteries;
one or more speakers;
one or more microphones;
one or more connectors; and
audio processing circuitry coupled with the one or more microphones, the one or more connectors and the one or more speakers, wherein the audio processing circuitry is operable to selectively combine audio signals from the one or more microphones with audio signals from the one or more connectors based on at least the audio signals from the one or more connectors and output the combination to the one or more speakers.

23. The device of claim 21 wherein the one or more speakers are part of a headphone apparatus.

24. The device of claim 21 further comprising:
a user interface that is operable to control the audio processing circuitry.

25. The device of claim 22 wherein the user interface comprises:
a fader for controlling the volume of the signals from the one or more microphones.

26. The device of claim 24 wherein the volume controlled by the fader is the relative volume of the signals from the one or more microphones compared to the signals from the one or more connectors.

27. A portable audio blending system comprising:
a headset comprising:
one or more speakers;
one or more microphones; and
wireless communications circuitry coupled with the one or more speakers and the one or more microphones; and
an audio generation device comprising:
wireless communications circuitry;
a source of internal audio signals; and
audio processing circuitry coupled with the wireless communications circuitry and the source of internal audio signals, wherein the audio processing circuitry is operable to selectively combine audio signals from the one or more microphones with internal audio signals based on at least the audio signals from the one or more microphones and output the combination to the one or more speakers in the headset.

28. A wireless headset comprising:
one or more batteries;
one or more speakers;
one or more microphones;
wireless communications circuitry; and
audio processing circuitry coupled with the one or more microphones, the wireless communications circuitry, and the one or more speakers, wherein the audio processing circuitry is operable to selectively combine audio signals from the one or more microphones with audio signals from the wireless communications circuitry based on at least the audio signals from the one or more microphones and output the combination to the one or more speakers.
